(19) United States
(12) Patent Application Publication
(10) Pub. No.: US 2006/0121784 A1
(43) Pub. Date: Jun. 8, 2006

(54) Electromagnetic interference shield

(75) Inventor: Chieh Lee, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/259,663

(22) Filed: Oct. 26, 2005

(30) Foreign Application Priority Data
Dec. 4, 2004 (CN) 200420102413.2

(51) Int. Cl. H01R 13/648

(52) U.S. Cl. 439/607

(57) ABSTRACT

An Electromagnetic Interference (EMI) shield (100) of electronic devices is disclosed. The EMI shield includes a frame body (120) and a cover (110). The frame body includes a flat top (121) formed on one side thereof, at least two engaging holes (125), and an opening defined in the flat top. The cover includes a blocking plate (114) and at least two engaging members (111) connected to the blocking plate. The blocking plate of the cover contacts the flat top of the frame body, and the engaging members are engaged in the corresponding engaging holes of the frame body.

### BACKGROUND

1. Field of the Invention

The present invention relates to Electromagnetic Interference (EMI) shielding apparatuses, and particularly to EMI shields of electronic devices.

2. Related Art

EMI occurs between neighboring electronic components or circuitries due to inductive coupling therebetween. EMI sources include inverters, diodes, transistors, amplifiers, power supplies, and other circuits of electronic devices. The effective performance of electronic devices can be interrupted, obstructed, or degraded by EMI. One popular solution developed to avoid the occurrence of EMI is to employ a metal EMI shield to absorb as much EMI radiation energy as possible.

A conventional RF (Radio Frequency) shield 300 is shown in FIG. 3. The RF shield 300 comprises a cover 310 and a frame 320. The cover 310 is a central portion of the RF shield 300, and surrounded and defined by a peripheral shear line 311. Four corner portions of the cover 310 are bent upwardly to form four bent portions 312, for facilitating removal of the cover 310 from the frame 320 by means of a tool such as a screwdriver. However, once the cover 310 is removed from the frame 320, the RF shield 300 cannot be used again.

FIG. 4 shows another conventional EMI shield 400. The EMI shield 400 comprises a cover 410 and a frame 420. Two pairs of guiding tabs 421 are formed on opposite lengthwise sidewalls of the frame 420, respectively. Gaps are defined between the guiding tabs 421 and top surfaces of the lengthwise sidewalls, for receiving the cover 410 therein and allowing the cover 410 to be slidable along a lengthwise direction. In addition, the frame 420 comprises a fixation hole (not labeled), for receiving a positioning pin 411 to secure the cover 410 to the frame 420. When electronic components enclosed in the EMI shield 400 are required to be maintained or replaced by other components, the cover 410 can be removed from the frame 420. The position pin 411 is disengaged from the fixation hole, and then the cover 410 is moved from a closed position where the frame 420 is covered by the cover 410 to an open position where the cover 410 is slid out away from the frame 420. The electronic component is conveniently taken out and re-inserted or replaced, whereupon the cover 410 can be moved back from the open position to the closed position. However, an additional space must be available around the EMI shield 400 for accommodating the opened cover 410, when detaching the cover 410 from the frame 420, increasing volume of the EMI shield.

Therefore, a heretofore unaddressed need exists in the industry to address the aforementioned deficiencies and inadequacies.

### SUMMARY OF THE INVENTION

An EMI shield of an embodiment of the present invention includes a frame body and a cover. The frame body includes a flat top formed on one side thereof, at least two engaging holes defined on the flat top, and an opening defined in the flat top, allowing access to electronic elements received in the EMI shield from an exterior thereof. The cover includes a blocking plate and at least two engaging members depending from the blocking plate. The blocking plate of the cover comes into contact with the flat top of the frame body, and the at least two engaging members are disengageably engaged in the corresponding at least two engaging holes of the frame body.

The structure of the EMI shield is compact, and assembling and disassembling of the EMI shield are only performed above the frame body, without the need for extra neighboring space around the EMI shield.

Other advantages and novel features will be drawn from the following detailed description with the attached drawings, in which:

### BRIEF DESCRIPTION OF THE DRAWINGS

FIG. 1 is an exploded, isometric view of an EMI shield in accordance with a preferred embodiment of the present invention;

FIG. 2 is an isometric, inverted view of the EMI shield of FIG. 1 fully assembled;

FIG. 3 is an isometric view of a conventional RF shield used in electronic devices; and

FIG. 4 is an isometric view of another conventional EMI shield used in electronic devices.

### DETAILED DESCRIPTION OF PREFERRED EMBODIMENT

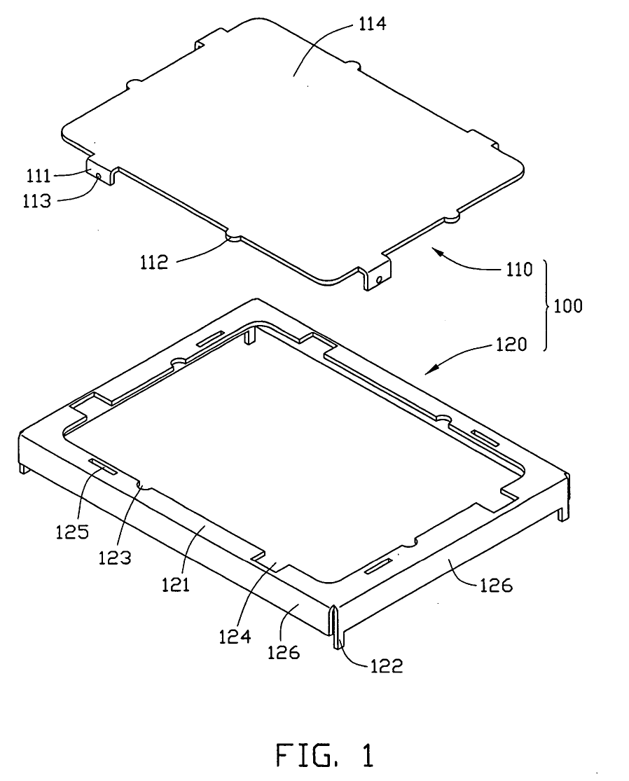

FIG. 1 is an exploded, isometric view of an EMI shield 100 according to a preferred embodiment of the present invention. The EMI shield 100 comprises a cover 110 and a frame body 120. The frame body 120 comprises four sidewalls 126 and a flat top 121. Two pairs of mounting legs 122 extend from the breadthwise sidewalls 126, for inserting into corresponding holes defined in a substrate and fixing the frame body 120 thereto. The sidewalls 126 are connected perpendicularly to edges of the flat top 121, respectively. An opening is defined in the flat top 121, for allowing an operator to access electronic elements received in the EMI shield 100 from an exterior when necessary. The shape of the opening is same as a flattened shape of the cover 110. The flat top 121 comprises four first cutouts 123, four second cutouts 124, and four engaging holes 125. In this embodiment, the first cutouts 123 are substantially semicircular, and are provided for facilitating disengagement of four engaging members 111 from the engaging holes 125. The second cutouts 124 are substantially rectangular, and are provided for facilitating detachment of the cover 110 from the frame body 120. The engaging holes 125 are shaped as slots 125, receiving the engaging members 111 (Described hereinafter). The cover 110 comprises a blocking plate 114 and the engaging members 111. The blocking plate 114 comprises four support tabs 112 extending outwardly from four edges thereof respectively, for supporting the cover 110 on the frame body 120 when the cover 110 is attached to the frame body 120. The support tabs 112 are substantially semicircular. Each engaging member 111 comprises a rectangular bent portion 111 with a protrusion 113 formed thereon. The protrusion 113 is substantially dome-shaped or hemispherical. An area of the cover 110 is substantially equal to that of the opening of the flat top 121.

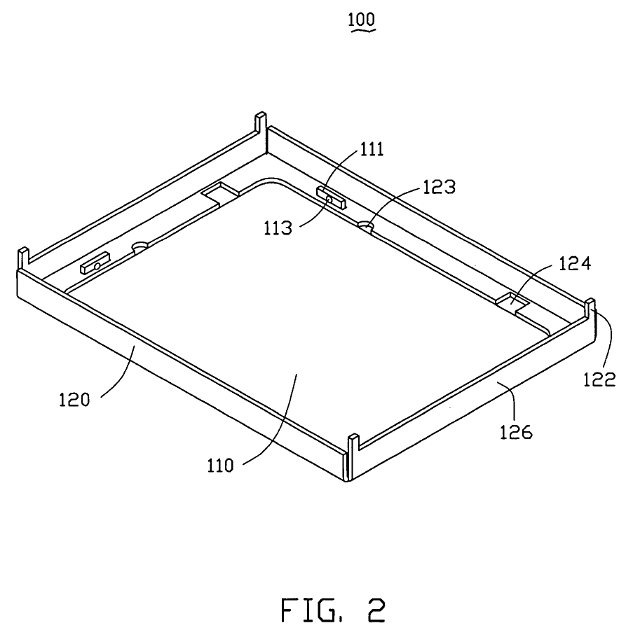

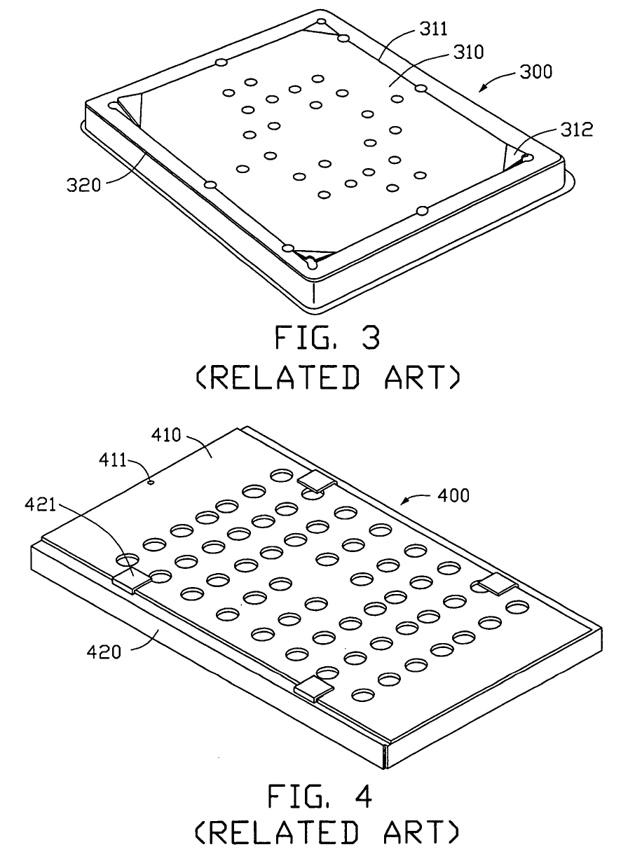

FIG. 2 is an isometric, inverted view of the EMI shield 100 after assembly. The cover 110 contacts the frame body 120 at the opening. The rectangular bent portions 111 are inserted into the slots 125, and are latchingly engaged in the engaging holes 125 by the protrusions 113. The cover 110 and the frame body 120 are thus attached to each other securely. The support tabs 112 abut against the flat top 121. When the cover 110 needs to be removed from the frame body 120, a tool such as a screwdriver is inserted into one of the second cutouts 124, so as to disengage the cover 110 from the frame body 120. Understandably, assembling and disassembling of the EMI shield 100 are performed above the frame body 120, without the need for extra space around the EMI shield 100, for reducing size thereof.

Although only an exemplary embodiment has been described in detail above, those skilled in the art will readily appreciate that many modifications to the exemplary embodiment are possible without materially departing from the novel teachings and advantages of the present invention. Accordingly, all such modifications are deemed to be covered by the following claims and allowable equivalents of the claims.

We claim:

1. An Electromagnetic Interference (EMI) shield of electronic devices, the EMI shield comprising:
a frame body comprising a flat top formed on one side thereof, at least two engaging holes defined on the flat top, and an opening defined in the flat top for allowing access to electronic elements received in the EMI shield from an exterior thereof; and
a cover comprising a blocking plate and at least two engaging members connected to the blocking plate, wherein the blocking plate contacts the flat top of the frame body, and the engaging members are detachably disposed in the corresponding engaging holes of the frame body.

2. The EMI shield as recited in claim 1, wherein the frame body further comprises sidewalls, perpendicularly connected to the flat top.

3. The EMI shield as recited in claim 1, wherein an area of the cover is substantially equal to that of the opening of the flat top.

4. The EMI shield as recited in claim 1, wherein the engaging members comprise rectangular bent portions.

5. The EMI shield as recited in claim 4, wherein each bent portion comprises a protrusion formed thereon.

6. The EMI shield as recited in claim 5, wherein the protrusion is dome-shaped or hemispherical.

7. The EMI shield as recited in claim 1, wherein the flat top defines at least one cutout, formed on an edge in the vicinity of the opening, facilitating detachment of the cover from the frame body.

8. The EMI shield as recited in claim 1, wherein the blocking plate comprises at least one support tab extending outwardly from an edge thereof.

9. The EMI shield as recited in claim 1, wherein the frame body comprises at least two mounting legs extending from the flat top.

10. An assembly comprising:
an electronic device;
a frame body disposed around said electronic device to define a space therein for accommodating said electronic device in said space, said frame body capable of providing Electromagnetic Interference (EMI) shielding around said electronic device and defining an opening at a side thereof so as to communicate said space with an outside of said frame body via said opening; and
a cover capable of covering said opening of said frame body to provide said EMI shielding in cooperation with said frame body, said cover comprising at least one engaging member extending therefrom toward said frame body so as to removably and guidably engage with said frame body along a direction intersecting with said side of said frame body by means of said at least one engaging member.

11. The assembly as recited in claim 10, wherein said cover has a flattened shape same as a shape of said opening of said frame body.

12. A method to manufacture a shield assembly, comprising the steps of:
forming a frame body of said shield assembly from Electromagnetic Interference (EMI) shielding material to allow said frame body capable of providing EMI shielding for objects installed therein;
severing a cover from said frame body to define an opening on said frame body;
altering orientation of said cover relative to said frame body so as to allow said cover capable of covering said opening based on said altered orientation; and
machining said cover to provide said cover a removably engaging ability with said frame body beside said opening of said frame body.
